(19) United States
(12) Patent Application Publication
(10) Pub. No.: US 2013/0204735 A1
(43) Pub. Date: Aug. 8, 2013

(54) Previewing a Sign in an Online Store-Front Ordering Process

(71) Applicant: Renato Keshet, Haifa (IL)

(72) Inventor: Renato Keshet, Haifa (IL)

(21) Appl. No.: 13/817,681

(22) PCT Filed: Oct. 28, 2010
(86) PCT No.: PCT/US10/54526

§ 371 Date: Feb. 19, 2013

(51) Int. Cl. G06Q 30/06

(52) U.S. Cl. CPC G06Q 30/0643
USPC 705/26.5

(57) ABSTRACT

A first representation [102] of an intended location for a print product is received [202]. A position within the first representation [102] for the print product is then determined [204]. A perspective matrix for warping an image of the print product into the first representation is automatically determined [206]. The image of the print product is warped [208] into the first representation [102] based on the perspective matrix to achieve a second representation [124] of the intended location. The second representation [124] includes the first representation [102] with a placement of the print product therein. The second representation [124] is then displayed [210].

### BACKGROUND

Generally, print service providers are installing web-based store-front systems, which enable them to receive web-to-print orders in an automated way. During a typical ordering process, a customer of a print service provider logs in to a customized website on the print service provider server. The customer then uploads a file (e.g., PDF file) containing the job to be printed, and makes the order through the website.

### DESCRIPTION OF THE DRAWINGS

FIG. 1 is a block diagram of a system for performing a method for previewing a sign in an online store-front ordering process, according to one embodiment of the present technology,

FIG. 2A is a flow diagram of a method for previewing a sign in an online store-front ordering process, according to one embodiment of the present technology.

FIG. 2B is a flow diagram of a method for previewing a sign in an online store-front ordering process, according to one embodiment, of the present technology,

FIG. 3 is a diagram of an example computer system used for performing a method for previewing a sign in an online store-front ordering process, according to one embodiment of the present technology

The drawings referred to in this description should not be understood as being drawn to scale unless specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following detailed description, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments,

Unless specifically stated otherwise as apparent from the following discussions, it is appreciated that throughout the present detailed description, discussions utilizing terms such as “receiving”, “determining”, “warping”, “displaying”, “altering”, “modifying”, “processing”, “previewing”, or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The present technology is also well suited to the use of other computer systems such as, for example, optical computers.

The discussion will begin with a brief overview of the process of purchasing signage on-line. The discussion will then focus on embodiments of the present technology that provide a system and method for previewing a sign in an online store-front ordering process.

### Overview

In general, ordering signage jobs through an online store-front system involves a customer logging in to a customized website on a print service provider server, uploading a PDF file containing the desired job to be printed, and then making the order for the signage through the website.

However, signage buyers may become disappointed after placing a purchased print at its intended location. The signage buyer may realize, after the fact, that the text on the sign is not large enough, the colors are not appropriate to the surroundings, or other problems that may not be imagined at the time of the signage purchase.

Embodiments of the present technology provide a signage preview system in the online store-front system such that a signage buyer may determine, prior to purchasing the sign, possible irregularities or inappropriate or undesired formatting. In other words, embodiments provide a method, in a job submission system, for previewing a desired print product at a desired and intended location, with the intent of providing the print buyer with the means for approving the manufacturing of the print product (print job) before the print buyer actually buys the print product. In this manner, the print buyer has the opportunity to preview his order before buying, thereby allowing time for needed modifications.

In embodiments of the present technology, the signage buyer may upload, in addition to a PDF file, one or more photographs that include(s) the location where the print (signage) is intended to be physically placed. Next, the buyer may be asked to mark with a few mouse clicks the position of that location within the photograph(s). Embodiments then present to the buyer a preview of what the print will look like when physically placed in the desired location.

For example, embodiments electronically insert the print image within the image of the photograph, in the correct, location, perspective, shadow and colors, thereby simulating the actual physical placement. If the buyer is satisfied, the buyer can then proceed to finalizing the order.

The following discussion will begin with a description of the structure of the components of the present technology. The discussion will then be followed by a description of the components in operation.

### Structure

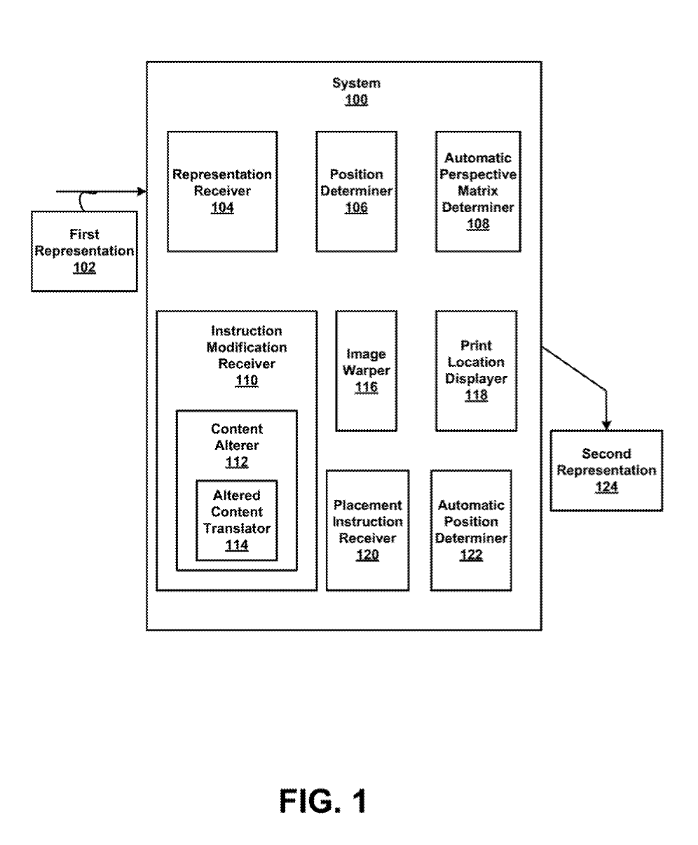

FIG. 1 is a block diagram of a system for previewing a sign in an online store-front ordering process, according to one embodiment of the present technology. Referring now to FIG. 1, the system includes a representation receiver 104, a position determiner 106, an automatic perspective matrix determiner 108, an image warper 116 and a print location displayer 118.

In other embodiments, the system may also include an instruction modification receiver 110, a placement instruction receiver 120 and an automatic position determiner 122 106. In embodiments, the instruction modification receiver 110 may include a content alterer 112 and an altered content translator 114.

In one embodiment, the representation receiver 104 receives a first representation 102 of an intended location of a print product. A print product is a print-job that the buyer desired for a print service provider to create. The print product is essentially a display of some type. For example, the print product may be a “sign”. The sign may have displayed thereon, but not limited to, text, photographs, drawings, etc. Further, in one embodiment, the representation receiver 104 receives a first representation 102 of an intended location for an object other than a print product.

In one embodiment, the first representation 102 is a photograph. in another embodiment, the first representation 102 is a set of instructions to retrieve the photograph of the intended, location via the internet. In yet another embodiment, the first representation 102 is a simulated representation of the intended location. For example, an area that has not yet been constructed (a building) is simulated through various computer programs, such that a user can see what a print job would look like if the intended location were actually developed as intended,

The intended location may be any location that is capable of being represented and interpreted by the system. For example, an intended location may be a school yard, a front entrance of a commercial building, or a stadium wall.

In one embodiment, the position determiner 106 determines a position within the first representation 102 for the print product. In one embodiment, the position determiner 106 includes an automatic position determiner 122 106. The automatic position determiner 122 106 determines the position of the print product according to predetermined instructions. In one embodiment, the system is preprogrammed with instructions regarding placement of displays. For example, the system may be preprogrammed with instructions for placing large signs closer to a building within the first representation 102 of the intended location and small signs further away from the building and closer to those passing by the building.

In one embodiment, the position determiner 106 includes a placement instruction receiver 120, The placement instruction receiver 120 receives placement instructions from an input device. The placement instructions indicate a position within the first representation 102 for the print product. In one embodiment, the input device is a mouse. For example, a user may use a display screen to view a graphical user interface (GUI) associated with the system. The user then uses a mouse to enter selected choices from a plurality of selectable choices offered via the GUI. Other inputs, such as keyboards, PDAs, cell phones, etc., as are commonly used in the industry may also be employed by a user to communicate selections and instructions to the position determiner 106.

In one embodiment, the automatic perspective matrix determiner 108 automatically determines a perspective matrix for warping an image of the print product into the first representation 102. Of note, the method of using a perspective matrix for warping an image to fit within another image is known by those of ordinary skill in the art.

In one embodiment, the image warper 116 warps the image of the print product into said first representation 102 based on the perspective matrix to achieve a second representation 124 of the intended location. The second representation 124 comprises the first representation 102 with a placement of the print product therein. Thus, for example, as a result of the image warper 116, a simulated image of the print product image within the photograph is now viewable, as a “second representation 124”, to the print buyer.

In one embodiment, the print location displayer 118 displays the second representation 124. This second representation 124 is displayed to the buyer, through for example, but not limited to, a display screen of a cell phone, in one embodiment, the second representation 124 shows the simulated shadows associated with the insertion of the print product within the first representation 102. For example, if the second representation 124 includes a large sign placed on a grassy knoll, the ground area that is displayed behind the sign may show a shadow, Thus, in this example, the preview shows a view of the sign during the morning hours. As can be seen, the system is capable of simulating different times of the day during which a sign is viewed.

Further, the system is capable of simulating different weather patterns within the preview. For example, a buyer is able to determine the ability to view a sign during a rainy day, a snowy day, a foggy day, etc.

In one embodiment, the second representation 124 shows simulated colors associated with the insertion of the print product within the first representation 102. For example, a buyer is able to determine if the colors desired for the sign work with the colors in the sign's surrounding environment. For example, if a sign is placed in front of a brown brick building, a tan colored sign might be determined, through the use of the preview, as being inadequate because the tan sign blends too well into the background of the brown brick building.

In one embodiment, the instruction modification receiver 110 receives modification instructions associated with the print product. The modification instructions change the content of the print product. In one embodiment, the modification instructions are received from an input device of a user. In other embodiments, the modification instructions are received, via a server. For example, a print provider service updates its system to include different perspective matrix instructions or different position determining instructions. These updated instructions are then translated into instructions that affect the second representation 124 of the print product.

In one embodiment, the content alterer 112 of the instruction modification receiver 110, based on said modification instructions, alters the content of the print product to achieve an altered content. For example, a user may decide that the text on a sign needs to be larger. The user will give these instructions to the system. The system will then change the font size on the sign.

In one embodiment, the altered content translator 114 of the instruction modification receiver 110 communicates the altered content of the print product to the position determiner 106 such that the position determiner 106 is able to determine a position within the first representation 102 for the print product, Following the example in which the user gave instructions to the system to change the font size of the sign to get an “altered content”, the altered content translator 114 sends the altered content to the position determiner 106 in a format that the position determiner 106 can understand in order that the position determiner 106 may again determine a position within the first representation 102 for the print product. In this situation, the position determiner 106 already knows the intended location of the print product, that had been received by the representation receiver 104 before the content of the print product was altered. Thus, a user/buyer does not have to upload another photograph to the system in order for the position determiner 106 to function. Further, in one embodiment, the position determiner 106 “remembers” the determined position within the first representation 102 for the print product. The position determiner 106 will use its remembered determined position unless the position determiner 106 receives a placement instruction from an input device for a position different from the originally selected position.

In one embodiment, the system is coupled with a server that is accessible via a customized website. For example, a print service provider has a web site dedicated to receiving orders for print products. A buyer may access this web site and order the print product there through. In another embodiment, the system is available at the print provider service, and is either coupled or not coupled with a server. In yet another embodiment, the system may be purchased at a store and downloaded onto a buyer's personal computer,

Thus, embodiments of the present technology enable buyers to preview signage jobs through an online store-front system, thereby avoiding likely problems, such as buying a sign with the wrong colors or wrong font size. Additionally, embodiments reduce the number of print returns and requested reprints, thereby saving both the buyer's and the provider's resources.

### Operation

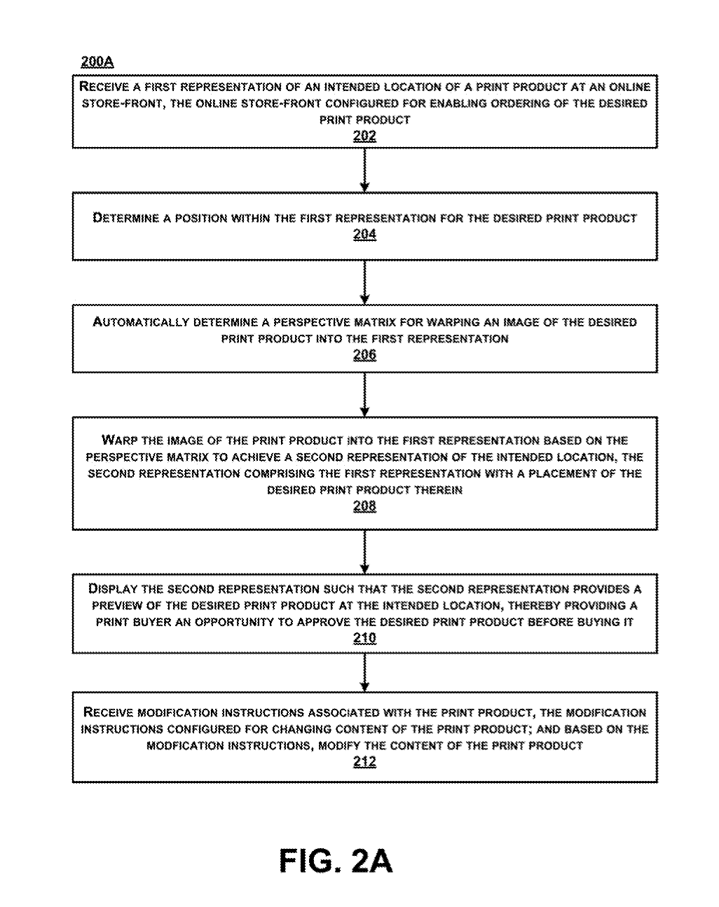

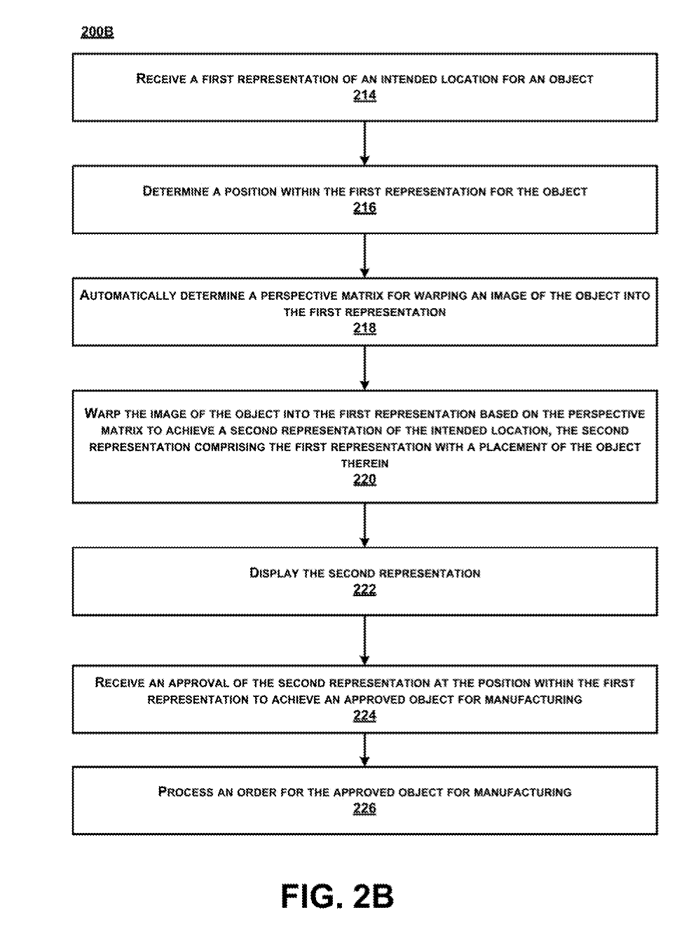

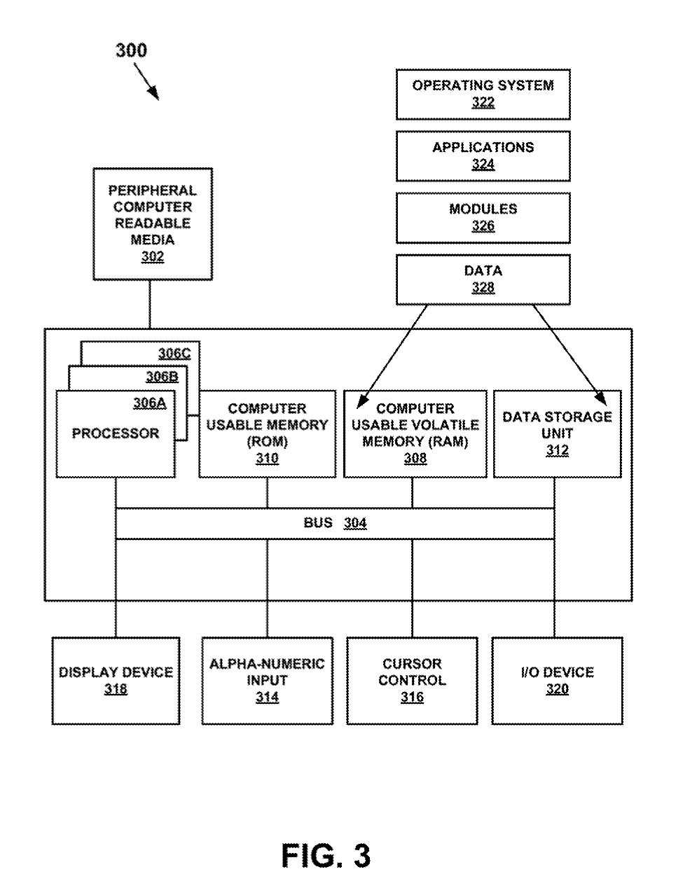

FIG. 2A is a flow diagram of a method 200A. In one embodiment, method 200A is embodied in instructions, stored on a non-transitory computer-readable storage medium, which when executed by a computer system (see 300 of FIG. 3), cause the computer system to perform the method 200A for previewing a sign in an online store-front ordering process. The method 200A is described below with reference to FIG. 1.

At 202, in one embodiment and as described herein, the method 200A includes receiving a first representation 102 of an intended location of a desired print product at an online store-front. The online store-front is configured for enabling ordering of the desired print product. Further, in one embodiment, a photograph is received at the intended location.

At 204, in one embodiment and as described herein, the method 200A includes determining a position within the first representation 102 for the desired print product. In one embodiment, placement instructions indicate a position within the first representation 102 for the print product. In one embodiment, the placement instructions are received from an input device. In another embodiment, the position within the first representation 102 is automatically determined according to predetermined instructions.

At 206, in one embodiment and as described herein, the method 200A includes automatically determining a perspective matrix for warping an image of the desired print product into the first representation 102.

At 208, in one embodiment and as described herein, the method 200A includes warping the image of the print product into the first representation 102 based on the perspective matrix to achieve a second representation 124 of the intended location. The second representation 124 is the first representation 102 with a placement of the print product therein.

At 210, in one embodiment and as described herein, the method 200A includes displaying the second representation 124 such that the second representation 124 provides a preview of the desired print product at the intended location. Thus, an embodiment enables the print buyer an opportunity to approve the desired print product before buying it. In one embodiment, simulated shadows associated with the insertion of the print product within the first representation 102 is displayed. In another embodiment, simulated color associated with the insertion of the print product within the first representation 102 is displayed.

At 212, in one embodiment and as described herein, the method 200A includes receiving modification instructions associated with the print product. The modification instructions are configured for changing content of the print product. Based on the modification instructions, the content of the print product is modified. Further, in one embodiment, a position within the first representation 102 for the altered print product is determined. In another embodiment, a perspective matrix for warping an image of the altered print product into the first representation 102 is automatically determined, In one embodiment, the altered print product is warped into the first representation 102 based on the perspective matrix to achieve a warped image. In one embodiment, the warped image that simulates a placement of the altered print product into the first representation 102 is displayed.

Thus, embodiments of the present technology are integrated within a web-based store-front system which enables a user to upload one or more image files containing photograph(s) of the intended location of a print product. The user is then able to indicate the desired position with the photograph for the print product. A perspective matrix for warping the image of the print product into the given photograph is automatically determined. Then, an image is displayed that simulates the placement of the print product within the photograph The print buyer is thus able to preview online the desired print product at its intended location before ordering it. If necessary, the print buyer may request modifications of the print product. After these modifications are made, the print buyer may again preview the desired print product at the intended location.

FIG. 2B is a flow diagram of a method 200B. In one embodiment, method 200B is embodied in instructions, stored on a non-transitory computer-readable storage medium, which when executed by a computer system (see 300 of FIG. 3), cause the computer system to perform the method 200B for previewing a sign in an online store-front ordering process. The method 200B is described below with reference to FIG. 1.

At 214, in one embodiment and as described herein, the method 200B includes receiving a first representation 102 of an intended location of object.

At 216, in one embodiment and as described herein, the method 200B includes determining a position within the first representation 102 for the object.

At 218, in one embodiment and as described herein, the method 200B includes automatically determining a perspective matrix for warping an image of the object into the first representation 102.

At 220, in one embodiment and as described herein, the method 200B includes warping the image of the object into the first representation 102 based on the perspective matrix to achieve a second representation 124 of the intended location. The second representation 124 is the first representation 102 with a placement of the object therein.

At 222, in one embodiment and as described herein, the method 200A includes displaying the second representation 124.

At 224, in one embodiment and as described herein, the method 200B includes receiving an approval of the second representation 124 at the position within the first representation 102 to achieve an approved object for manufacturing.

At 226, in one embodiment and as described herein the method 200B includes processing an order for the approved object for manufacturing.

Embodiments of the present technology enable a buyer/user to preview a print product positioned at the intended location in order to determine if the print product as positioned gives the desired effect. The user may cause the contents of the print product to be modified if the user is unsatisfied with the preview. However, if the user is satisfied with the print product as seen in the preview, the user may decide to place an order for that print product.

### Example Computer System Environment

With reference now to FIG. 3, portions of the technology for previewing a sign in an online store-front ordering process are composed of computer-readable and computer-executable instructions that reside, for example, in computer-usable media of a computer system. That is, FIG. 3 illustrates one example of a type of computer that can be used to implement embodiments, which are discussed below, of the present technology.

FIG. 3 illustrates an example computer system 300 used in accordance with embodiments of the present technology. It is appreciated that system 300 of FIG. 3 is an example only and that the present technology can operate on or within a number of different computer systems including general purpose networked computer systems, embedded computer systems, routers, switches, server devices, user devices, various intermediate devices/artifacts, stand alone computer systems, and the like. As shown in FIG. 3, computer system 300 of FIG. 3 is well adapted to having peripheral computer readable media 302 such as, for example, a floppy disk, a compact disc, and the like coupled thereto.

System 300 of FIG. 3 includes an address/data bus 304 for communicating information, and a processor 306A coupled to bus 304 for processing information and instructions. As depicted in FIG. 3, system 300 is also well suited to a multi-processor environment in which a plurality of processors 306A, 3066, and 306C are present. Conversely, system 300 is also well suited to having a single processor such as, for example, processor 306A. Processors 306A, 3066, and 306C may be any of various types of microprocessors. System 300 also includes data storage features such as a computer usable volatile memory 308, e.g. random access memory (RAM), coupled to bus 304 for storing information and instructions far processors 306A, 306B, and 306C.

System 300 also includes computer usable non-volatile memory 310, e.g. read only memory (ROM), coupled to bus 304 for storing static information and instructions for processors 306A, 3068, and 3060. Also present in system 300 is a data storage unit 312 (e.g., a magnetic or optical disk and disk drive) coupled to bus 304 for storing information and instructions. System 300 also includes an optional alphanumeric input device 314 including alphanumeric and function keys coupled to bus 304 for communicating information and command selections to processor 306A or processors 306A, 3068, and 306C. System 300 also includes an optional cursor control device 316 coupled to bus 304 for communicating user input information and command selections to processor 306A or processors 306A, 306B, and 306C. System 300 of the present embodiment also includes an optional display device 318 coupled to bus 304 for displaying information.

Referring still to FIG. 3, optional display device 318 of FIG. 3 may be a liquid crystal device, cathode ray tube, plasma display device or other display device suitable for creating graphic images and alphanumeric characters recognizable to a user. Optional cursor control device 316 allows the computer user to dynamically signal the movement of a visible symbol (cursor) on a display screen of display device 318. Many implementations of cursor control device 316 are known in the art including a trackball, mouse, touch pad, joystick or special keys on alpha-numeric input device 314 capable of signaling movement of a given direction or manner of displacement. Alternatively, it will be appreciated that a cursor can be directed and/or activated via input from alpha-numeric input device 314 using special keys and key sequence commands.

System 300 is also well suited to having a cursor directed by other means such as, for example, voice commands. System 300 also includes an I/O device 320 for coupling system 300 with external entities. For example, in one embodiment, I/O device 320 is a modem for enabling wired or wireless communications between system 300 and an external network such as, but not limited to, the Internet. A more detailed discussion of the present technology is found below.

Referring still to FIG. 3, various other components e depicted for system 300. Specifically, when present, an operating system 322, applications 324, modules 326, and data 328 are shown as typically residing in one or some combination of computer usable volatile memory 308, e.g. random access memory (RAM), and data storage unit 312. However, it is appreciated that in some embodiments, operating system 322 may be stored in other locations such as on a network or on a flash drive; and that further, operating system 322 may be accessed from a remote location via, for example, a coupling to the internet. In one embodiment, the present technology, for example, is stored as an application 324 or module 326 in memory locations within RAM 308 and memory areas within data storage unit 312. The present technology may be applied to one or more elements of described system 300. For example, a method for identifying a device associated with a transfer of content may be applied to operating system 322, applications 324, modules 326, and/or data 328.

The computing system 300 is only one example of a suitable computing environment and is not intended to suggest any limitation as to the scope of use or functionality of the present technology. Neither should the computing environment 300 be interpreted as having any dependency or requirement relating to any one or combination of components illustrated in the example computing system 300.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

All statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

What we claim is:

1. A non-transitory computer-readable storage medium comprising instructions stored thereon which, when executed by a computer system, cause said computer system to perform a method [200] for previewing a sign in an online store-front ordering process, said method comprising:
receiving [202] a first representation of an intended location for a desired print product at an online store-front, said online store-front configured for enabling ordering of said desired print product;
determining [204] a position within said first representation for said desired print product;
automatically determining [206] a perspective matrix for warping an image of said desired print product into said first representation;
warping [208] said image of said print product into said first representation based on said perspective matrix to achieve a second representation of said intended location, said second representation comprising said first representation with a placement of said desired print product therein; and
displaying [210] said second representation such that said second representation provides a preview of said desired print product at said intended location, thereby providing a print buyer an opportunity to approve said desired print product before buying it.

2. The method [200] of claim 1, further comprising:
receiving [212] modification instructions associated with said print product, said modification instructions configured for changing content of said print product; and
based on said modification instructions, modifying said content of said print product

3. The method [200] of claim 2, further comprising:
determining a position within said first representation for said altered print product;
automatically determining a perspective matrix for warping an image of said altered print product into said first representation;
warping said altered print product into said first representation based on said perspective matrix to achieve a warped image; and
displaying said warped image that simulates a placement of said altered print product into said first representation.

4. The method [200] of claim 1, wherein said determining a position within said first representation for said print job comprising;
receiving placement instructions that indicate a position within said first representation for said print product.

5. The method [200] of claim 4, wherein said receiving placement instructions that indicate a position within said first representation for said print product comprises:
receiving said placement instructions from an input device.

6. The method [200] of claim 1, wherein said determining a position within said first representation for said print product comprises:
automatically determining said position within said first representation according to predetermined instructions.

7. The method [200] of claim 1, wherein said receiving a first representation of an intended location of a print product to be posted comprises:
receiving a photograph of said intended location.

8. The method [200] of claim 1, wherein said displaying said second representation comprises:
displaying simulated shadows associated with the insertion of said print product within said first representation.

9. A system [100] comprising:
a representation receiver [104] configured for receiving a first representation [102] of an intended location for a print product:
a position determiner [106] configured for determining a position within said first representation [102] for said print product;
automatic perspective matrix determiner [108] configured for automatically determining a perspective matrix for warping an image of said print product into said first representation [102];
an image warper [116] configured for warping said image of said print product into said first representation [102] based on said perspective matrix to achieve a second representation [124] of said intended location, said second representation [124] comprising said first representation [102] with a placement of said print product therein; and
a print location displayer [118] configured for displaying said second representation [124].

10. The system [100] of claim 9, further comprising:
an instruction modification receiver [110] configured for receiving modification instructions associated with said print product, said modification instructions configured for changing content of said print product.

11. The system [100] of claim 10, further comprising:
a content alterer [112] configured for, based on said modification instructions, modifying said content of said print product to achieve an altered content.

12. The system [100] of claim 11, further comprising:
an altered content translator [114] configured for communicating said altered content of said print product to said position determiner [106] such that said position determiner [106] is able to determine a position within said first representation [102] for said print product.

13. The system [100] of Claim g, wherein said position determiner [106] comprises:
a placement instruction receiver [120] configured for receiving placement instructions from an input device, said placement instructions indicating a position within said first representation [102] for said print product.

14. The system [100] of claim 9, wherein said placement determiner [106] comprises:
an automatic position determiner [122] configured for automatically determining said position within said first representation [102] according to predetermined instructions

15. A computer-implemented method for previewing an object in an online store-front ordering process, said computer-implemented method [200B] comprising:
receiving [214] a representation of an intended location for an object;
determining [216] a position within said representation for said object;
automatically determining [218] a perspective matrix for warping an image of said object into said representation;
warping [220] said image of said object into said representation based on said perspective matrix to achieve a second representation that simulates a placement of said object into said first representation;
displaying [222] said second representation: and
receiving [224] an approval of said second representation at said position within said first representation to achieve an approved object for manufacturing;
processing [226] an order for said approved object for manufacturing.
